(19) United States
(12) Patent Application Publication
(10) Pub. No.: US 2014/0305384 A1
(43) Pub. Date: Oct. 16, 2014

(54) Vehicular dog restraint

(71) Applicant: Melissa Ramirez, Chicago, IL (US)

(72) Inventor: Melissa Ramirez, Chicago, IL (US)

(21) Appl. No.: 13/862,456

(22) Filed: Apr. 14, 2013

(51) Int. Cl. A01K 27/00

(52) U.S. Cl. CPC A01K 27/002
USPC 119/771

(57) ABSTRACT

Disclosed is an improved dog vehicular restraint comprising a loop end, a fastener end to connect to a dog's existing harness, an adjuster to vary the length, and a construction capable of restraining a dog during abrupt movements such as sudden stops, acceleration, or change in direction. In particular, the improved device is suited to smaller dogs with more sensitive bone and soft tissue structures, and typically use a more custom fitted harness. The device allows for use of the existing harness and the inherent safety features of a typical car seat belt, such as an automatic locking retractor. Also, the device is designed to promote convenience, which increases the likelihood of use, and thus promotes dog and passenger safety in vehicles.

### FIELD OF INVENTION

The present invention generally relates to pet restraint systems for use in vehicles. More specifically, the present invention relates to an improved dog seat belt, in order to improve and encourage dog and passenger safety in vehicles. Additionally, the present invention serves to benefit small dogs.

### BACKGROUND OF THE INVENTION

Pets are commonly transported in vehicles and exposed to the hazards of abrupt movements or even accidents. Some routine hazards result from breaking, accelerating, turning, and other typical automotive movements. These hazards can result in serious injury to pets placed on car seats, dashboards, foot wells, or other areas in a vehicle.

Additionally, an unsecured pet may also lead to a distracted driver, which leads to even more safety concerns that affect all passengers as well as other vehicles on the road.

Although most vehicles inherently provide safety features such as seat belts and airbags, such restraints may not adequately protect a human passenger from an unsecured pet within a vehicle, during abrupt movements. As a result, all passengers are subject to risk despite an automobile's inherent safety features.

A number of pet restraints have been developed. However, general statistics show that pet owners have not sufficiently adopted these measures.

According to the American Automobile Association, “unrestrained pets cause more than 30,000 accidents annually,” despite the availability of pet restraints.

As few as 2% of people buckle in their dogs, according to general statistics on a dog safety website (http://www.barkbuckleup.com/). The risks seem even greater, considering over 71 million homes in America have a pet, and 50% of those have more than one pet. Furthermore, it has been reported that 82% of pets travel on vacation with their owners.

In recent years, pet travel appears to be increasing. Pet friendly lodging increased 300% from 2005-2007. In a related note, consumer spending in the pet industry reached $47.7 billion (http://www.barkbuckleup.com) in 2010.

This increase in travel with pets may be a reflection of what surveys have shown over the years, namely that pets help to lower blood pressure, reduce stress, help to prevent heart disease, help to lower human heath costs, and help to fight depression.

Despite the positive contribution of pets to the lives of their owners, safely securing a pet in a vehicle has not been a widely accepted practice. This may be related to lack of understanding the risks of an unrestrained pet in a vehicle, such as injury to the pet, injury to passengers, as well as the distracted driver causing injury to others outside the vehicle.

Also, there may be a lack of awareness that dog seatbelts exist, due to possibly limited distribution at readily accessible stores. Although many consumers shop online where choices are aplenty, many of these consumers may end up buying something they don't understand as far as being adequate for use with their particular pet.

Shopping for dog restraining devices maybe particularly troublesome, as dogs come in all shapes and sizes. With many different types of mechanisms, people may not really understand what is best for them or their dog.

One type of restraint features a built-in harness. These standardized harnesses may only fit certain shapes and sizes of dogs and would not be useful for others.

Another type of restraint features a box, container, or similar enclosing device. In the event of an accident, a dog may be thrown within or outside the box, which also risks injury.

Other restraints, while being adequate for safety, suffer from complicated attachments, which might lead to less usage due to inconvenience.

More simple seat belt devices are commercially available. However, many suffer from a lack of material strength in the event of an abrupt vehicular movement. This may be due to inadequate belt material, inadequate fastening of components, or other considerations such as improper length and adjustment, or slippage of length adjustment.

A number of patents and commercial products involving animal restraint systems attempt to address these various safety issues. U.S. Pat. No. 5,427,061 A (McCullough) teaches an animal restraint system, utilizing a car seat belt as an anchor. McCullough provides length adjustment of the animal restraint system in an attempt to address proper fitment (McCullough FIG. 3). However, McCullough suffers from the adjustment device and belt potentially allowing for full extension upon application of forces experienced in an accident or other abrupt vehicular movements. Such slippage can compromise the safety of the passengers, including the animal. Furthermore, the fastener embodiments disclosed in McCullough may be more susceptible to failure in the event of an accident (McCullough FIGS. 1 and 2, see fasteners 5a and 6b). Such fasteners in their apparent plastic or molded forms may be inadequate against the forces experienced in automotive collisions.

U.S. Pat. No. 5,864,927 A (Liu) discloses a prior art leash (Liu FIG. 1) without an adjuster, and a form with a buckle (Liu FIG. 5, see buckle 10). Although Liu suggests use in a vehicle (Liu col 1, ln 24-27), Liu does not discuss sourcing of proper materials to withstand forces in accidents. Nor does Liu address the issue of slippage or failure of its buckle. While the Liu disclosure may be perfectly adequate for steady vehicular movement, it does not adequately address abrupt vehicular movements, such as those experienced in accidents.

The prior art as shown in FIG. 1 offers a convenient system for securing a dog to a car seat belt. Using a simple belt that stays in the car, the pet owner may simply connect this device to the attachment point worn by the pet. However, this device may suffer from inadequate strength in the event of an accident for a number of reasons. The fastener is attached to one end of the belt, where that end is glued together. Furthermore, it is unclear weather the webbing, adjustment slide, and fastener are sufficient to withstand the heightened force generated by an otherwise small dog in an abrupt movement. Also, the length may not be ideal for smaller dogs.

A second prior art product as shown in FIG. 2 similarly offers the convenience of the belt left attached to a car seat belt, with the ease of attachment to the pet. However, this product does not offer adjustability, which may make this device potentially less comfortable for dogs, and ultimately less frequently used by owners.

Other products buckle directly into a car seat belt buckle. While these provide a secure connection, they are different products that don't use the inherent safety belt features of automobiles where in the event of a hard stop, the seat belts lock. Furthermore, such buckle products don't allow for as much flexibility of connection points compared to a restraint system that connects to seat belts.

As described above, the prior art suffers from one or more of the following inadequacies: fasteners that don't withstand forces for protection, webbing of inadequate strength for the belt material, an adjustment slide that is weak and/or does not adequately prevent slippage during forces, connection between webbing and fasteners such as glued parts rather than a more substantial stitching or other connection suitable for use in automotive vehicles where substantial forces may be experienced. Furthermore, some products present more complicated attachments potentially leading to less use of the restraint, and more frequent risk exposure.

### SUMMARY OF THE INVENTION

The invention overcomes these problems and shortcomings of the prior art. By promoting ease of use, the invention promotes dog safety in vehicles. Additionally, the invention addresses the heightened forces experienced in accidents through proper sourcing of materials and inherent connections improving the strength properties. Also, the invention lowers the risk of injury as a result of restraint by using the dog's existing proper-fitting harness. Furthermore, the invention balances dog comfort with length limitation to lessen contact in order to avoid injury.

The invention promotes ease of use and safety of dogs and passengers in vehicles in several ways.

First, the invention allows for ease of use by having a belt that can remain attached to a car seat belt, with one simple connection adapted for a dog's existing, proper-fitting harness.

Second, the invention promotes safety by providing for a combination of material, belt webbing, and fasteners in order to handle the heightened forces experienced in abrupt vehicular movements or accidents.

Also, the invention provides for a length and adjustment to balance the needs of dog comfort through some mobility, as well as a limit to keep the dog from contacting other passengers. By allowing for dog comfort, frequency of use is enhanced and safety risks are reduced.

More specifically, the limited length and connection to an existing proper-fitting harness provides a safe option for owners of small dogs who may have limited options in the market. Furthermore, by utilizing the dog's existing proper-fitting harness, the dog is less likely to slide out and experience external injury, or internal injuries as a result of having to use an ill-fitting collar or ill-fitting standardized harness restraint.

The invention comprises a belt having a first end and a second end. The first end has a loop, the loop adapted to connect to a car seat belt strap. The loop has a slide adjuster, the adjuster allowing for modifying the loop size to allow the loop to move across the car seat belt, the movement allowing for a dog to self-position comfortably, but limiting movement to avoid contact with inner vehicle components or other passengers.

The second end having a fastener, the fastener adapted to connect to a proper-fitting dog harness, wherein the harness secures the dog comfortably and does not slip off, nor offers the dog the ability to slip out or remove the harness. By allowing for use of a dog's existing proper-fitting harness, the invention improves on comfort and restraint over the prior art.

The dog seat belt in its full form is capable of withstanding 1500 lbs of force or withstands the force of a 25 lb dog in the event of an abrupt movement such as a car accident.

Additionally, the dog seat belt can be left attached to the buckled seat belt in the car, and simply attached to the dog by simple fastening of the second end with the receiving attachment of the dog existing proper-fitting harness. The ease of use promotes restraint of dogs by their owners in vehicles.

### BRIEF DESCRIPTION OF THE DRAWINGS

FIG. 1 is a perspective view of a prior art device;

FIG. 2 is a perspective view of a second prior art device;

FIG. 3 is a top plan view of one form of the device;

FIG. 4 is a perspective view of one form of the belt, depicting attachment to a seat belt;

FIG. 5 is an elevation view of one form of the belt, illustrating the belt as connected to a seat belt and the receiving connection of the dog's harness;

FIG. 6 is an enlarged view of FIG. 5, showing more closely the attachment of the belt to the harness;

FIG. 7 is an elevation view of one form, wherein the belt is connected to the dog, the dog in a comfortable position.

### DETAILED DESCRIPTION

FIG. 1 shows a prior art device.

FIG. 2 shows a second prior art device.

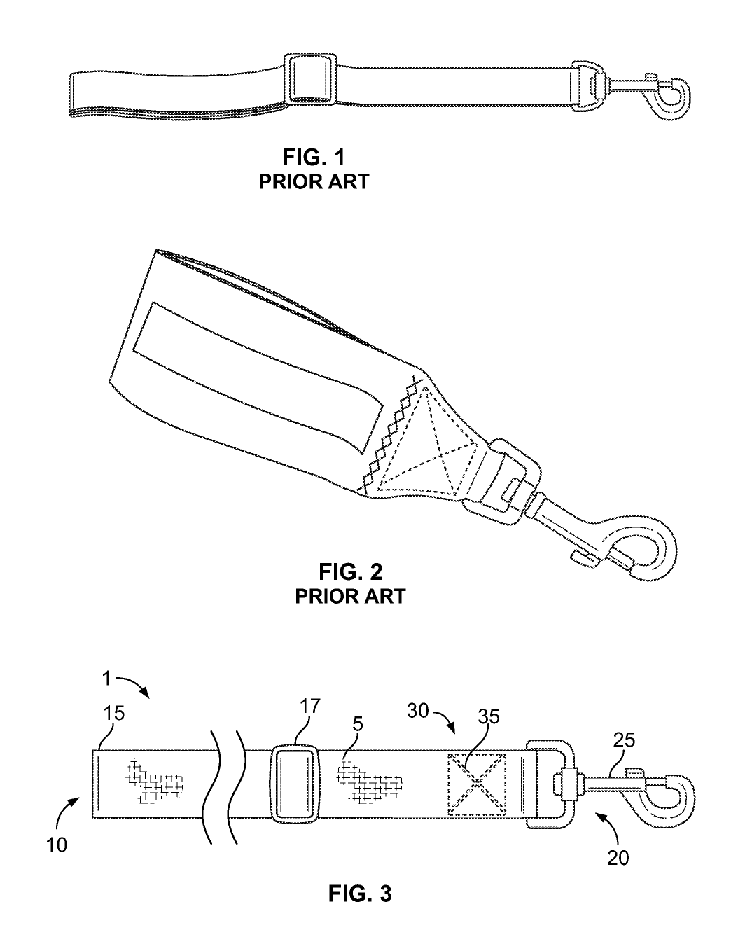

FIG. 3 shows one form of the invention, comprising a belt 1 with webbing 5, a first end 10, and a second end 20. The first end 10 has a loop 15. The second end 20 has a fastener 25. The belt having a heavy duty stitching 30, the stitching 30 depicted as in a double “X” pattern 35, secures the fastener 25.

The webbing 5 can be any strong fabric woven as a flat strip or tube of varying width and fibers, including but not limited to polypropylene, Dyneema, nylon, polyester, and Kevlar, cotton, and flax. The webbing 5 as depicted in FIG. 3 can have a width of 1″, 1 3/16″, 1 5/16″, 1 7/16″, 1 9/16″, 2″, or other suitable width in order to meet the application.

The loop 15 can be of a form that allows a dog to sit, stand, and turn to either side. However, it is long enough to not pull the dog backwards during abrupt vehicular deceleration. Nor is it too long where the dog may contact other passengers or internal vehicular components such as car front seats, ceiling, windows or doors. In one form, the belt has a maximum length of 13″ to benefit ease of movement for a small dog, while limiting range to minimize contact.

The loop 15 further allows for adjustment through a slide adjuster 17 as shown in FIG. 3. The slide adjuster 17 allows for adjusting the size of the loop 15 and the length of the belt 1. The slide adjuster 17 can be of the form of a cast metal slide, for example a 1″, 1 3/16″, 1 5/16″, 1 7/16″, 1 9/16″, 2″ or any other suitable size in order to meet the application.

The fastener 25 can be of the form of a bolt snap as depicted in FIG. 3. In one form, the fastener 25 is a 1″ silver bolt snap. However the fastener may be any suitable form or size for the vehicular application.

The stitching 30 as depicted in FIG. 3 in the form of the double “X” pattern 35 can be of the form of a Dual Duty XP® performance thread, other high strength polyester-wrapped, core spun construction, or any other suitable material.

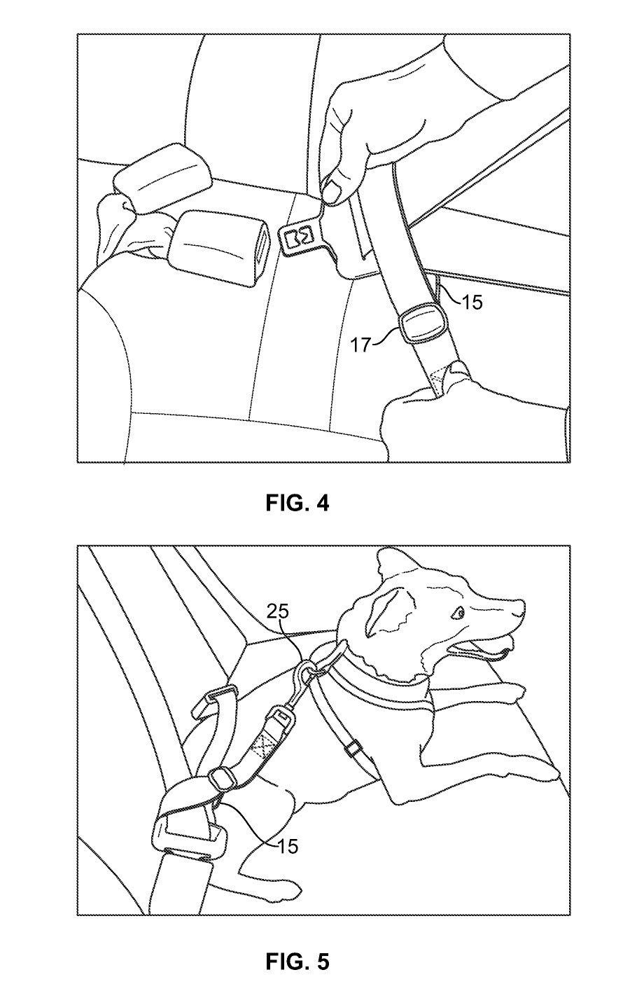

FIG. 4 shows a depiction of attaching the belt. The loop 15 can be looped around the car seat belt. For example, the loop can go around a rear car seat belt having a lap belt and shoulder strap. The rear car seat belt can then be attached into its connector. Such a configuration takes advantage of the car seat belt's built-in auto stop mechanism.

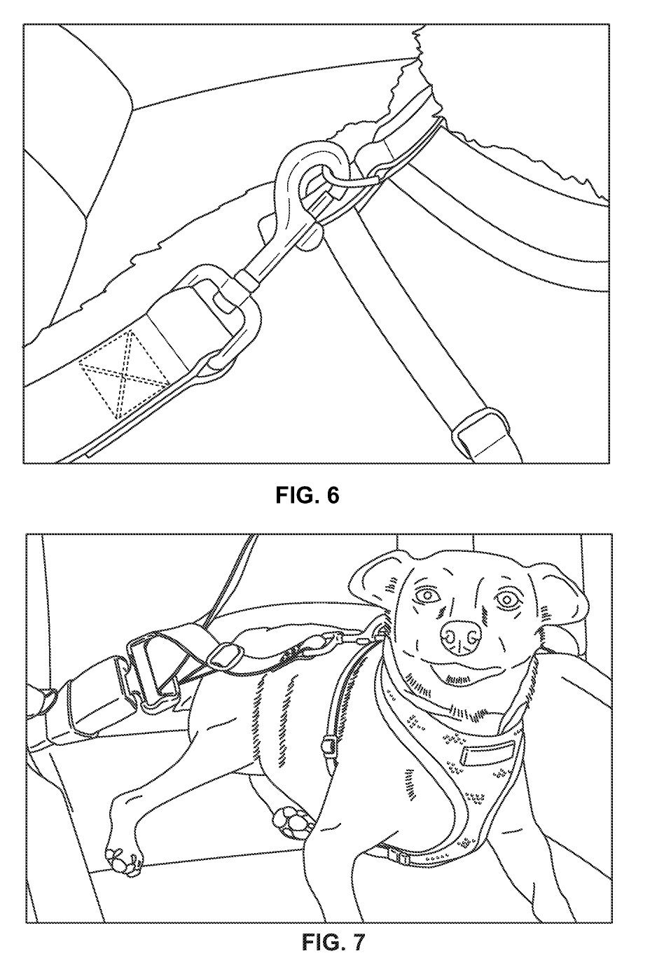

FIG. 5 shows both connections, where the loop 15 is connected to a rear car seat belt, and the fastener 25 is connected to a dog harness, where the dog is comfortably seated, in a secure position that allows for some minimal movement. The loop is connected to a rear car seat belt, taking advantage of a car seat belt's automatic locking retractor system. Such a system typically allows for some movement during steady velocities, but locks during abrupt movements such as sudden application of a car's braking system.

The fastener 25 in a one form as a bolt snap is shown in FIG. 6.

In FIG. 7, the dog is comfortably laying on a rear car seat. In another form, the dog can rest on added cushion or blanket to improve comfort.

I claim:

1. A dog seat belt comprising:
a) a webbing having a first end and a second end to a webbing body,
b) the first end having a loop, the loop adapted to connect to a car seat belt, the loop having an adjuster, the adjuster allowing for changing the loop length to allow for movement of the loop across the car seat belt, the movement allowing for a dog to self-position with enough range to achieve comfort but limited range so as to avoid contact with other vehicle occupants during abrupt vehicle movements,
c) the second end having a fastener, the fastener adapted to connect to a dog harness,
d) the dog seat belt capable of withstanding 450 lbs of force.

2. The dog seat belt in claim 1 further comprising:
a) the second end securing the fastener by stitching the second end to the webbing body.

3. The dog seat belt in claim 2, wherein:
a) the stitching comprising a double “X” pattern.

4. The dog seat belt in claim 1, wherein the fastener is a bolt snap.

5. The dog seat belt in claim 1, wherein the adjuster is a cast metal slide.

6. The dog seat belt in claim 3, wherein the stitching is of a high strength polyester-wrapped, core-spun construction.

7. The dog seat belt in claim 3, wherein the stitching is a Dual Duty XP performance thread.

8. The dog seat belt of claim 1, wherein the webbing is comprised of polypropylene.

9. The dog seat belt of claim 1, wherein the webbing is comprised of Dyneema.

10. The dog seat belt of claim 1, wherein the webbing is comprised of nylon.

11. The dog seat belt of claim 1, wherein the webbing is comprised of polyester.

12. The dog seat belt of claim 1, wherein the webbing is comprised of kevlar.

13. The dog seat belt of claim 1, wherein the adjuster is a titanium slide.

14. A pet restraint for use in vehicles, comprising:
a) a woven belt having a first end and a second end,
c) the first end having a loop, the second end securing a fastener,
d) the loop adapted to encircle a buckled car seat belt, the loop having a slide adjuster, the slide adjuster capable of adjusting the belt length,
e) the fastener adapted to connect to a pet harness,
f) the pet restraint capable of withstanding 1500 lbs of force.

15. The pet restraint of claim 14, wherein the woven belt is composed of polypropylene, Dyneema, nylon, polyester, or Kevlar.

16. The pet restraint of claim 15, wherein the woven belt is 1 9/16″ in width.

17. The pet restraint of claim 14, wherein the fastener is secured by stitching the second end with a double “X” stitching pattern.

18. The pet restraint of claim 14, wherein the stitching is a high strength polyester-wrapped, core-spun construction performance thread.

19. The pet restraint of claim 14, wherein the fastener is a 1″ bolt snap.

20. A small dog restraint for use in vehicles, comprising:
a) a woven belt consisting of polypropylene, Dyneema, nylon, polyester, or Kevlar,
b) the woven belt having a first end and a second end,
c) the first end having a loop, the loop adapted to envelop a buckled car seat belt,
d) the loop having a maximum length of 13″ but capable of size adjustment through a slide adjuster, the slide adjuster slidably connected to the loop, the slide adjuster composed of cast metal,
d) the second end securing a bolt snap fastener, the fastener having a base adapted to receive the second end of the woven belt, the fastener secured by inserting the second end of the belt through the base of the fastener and stitching the second end to the woven belt as to encircle the base of the fastener, the fastener adapted to connect to a dog harness,
d) the stitching in the form of a double “X” pattern, the stitching being a thread in the form of a Double Duty XP high performance thread,
e) the pet restraint capable of withstanding 1500 lbs of force.
